(19) United States
(12) Patent Application Publication
(10) Pub. No.: US 2020/0296129 A1
(43) Pub. Date: Sep. 17, 2020

(54) OPERATION SUPPORT APPARATUS, OPERATION SUPPORT TERMINAL, AND OPERATION SUPPORT METHOD

(71) Applicant: HITACHI SOLUTIONS, LTD., Tokyo (JP)

(72) Inventor: Kento IKEBUCHI, Tokyo (JP)

(73) Assignee: HITACHI SOLUTIONS, LTD., Tokyo (JP)

(21) Appl. No.: 16/535,601

(22) Filed: Aug. 8, 2019

(30) Foreign Application Priority Data
Mar. 12, 2019 (JP) 2019-044411

(51) Int. Cl. H04L 29/06; G06N 5/02

(52) U.S. Cl. CPC H04L 63/1441; H04L 63/1416; G06N 5/02

(57) ABSTRACT

An operation support apparatus comprises an acquisition unit configured to acquire log information upon occurrence of an incident, a prediction unit configured to predict an impact of the incident on operations on the basis of the log information, and an output unit configured to output a prediction result predicted by the prediction unit.

### CROSS-REFERENCE TO RELATED APPLICATIONS

This application is based upon and claims the benefit of priority from Japanese Patent Application No. 2019-44411, filed on Mar. 12, 2019; the entire contents of all of which are incorporated herein by reference.

### FIELD

The present invention relates to an operation support apparatus, an operation support terminal, and an operation support method capable of presenting information for decision making upon occurrence of an incident.

### BACKGROUND

When a corporation suffers a cyber attack, damage may spread and businesses may become severely impacted unless an appropriate countermeasure is implemented.

In addition, Japanese Patent Application Publication No. 2018-10441 discloses a technique to be used in a situation where a plurality of logs are being collected from a plurality of terminals to extract and collect only logs necessary for detecting an incident from time to time.

### SUMMARY

However, prior art fails to present information for decision making which enables a decision to be made with respect to what kind of countermeasure should be implemented in response to a cyber attack against a corporation.

The present invention has been made in consideration of the circumstances described above and an object thereof is to provide an operation support apparatus, an operation support terminal, and an operation support method capable of presenting information for decision making upon occurrence of an incident.

In order to achieve the object described above, an operation support apparatus according to a first aspect includes: an acquisition unit configured to acquire log information upon occurrence of an incident; a prediction unit configured to predict an impact of the incident on operations on the basis of the log information; and an output unit configured to output a prediction result predicted by the prediction unit.

According to the present invention, information for decision making upon occurrence of an incident can be presented.

### BRIEF DESCRIPTION OF THE DRAWINGS

FIG. 1 is a block diagram showing a configuration of an operation support system according to an embodiment;

FIG. 2 is a block diagram showing a configuration of an operation support apparatus shown in FIG. 1;

FIG. 3 is a flow chart showing an operation support method upon occurrence of an incident;

FIG. 4 is a diagram showing an example of log information shown in FIG. 2;

FIG. 5 is a diagram showing an example of ransomware information shown in FIG. 2;

FIG. 6 is a diagram showing an example of corporate information shown in FIG. 2;

FIG. 7 is a diagram showing a learning method of an AI (Artificial Intelligence) used as a prediction unit shown in FIG. 2;

FIG. 8 is a diagram showing examples of countermeasure plans upon occurrence of an incident;

FIG. 9 is a diagram showing an example of a report for each countermeasure plan shown in FIG. 8;

FIG. 10 is a diagram showing another example of a report for each countermeasure plan shown in FIG. 8;

FIG. 11 is a diagram showing an example of an extent of impact of ransomware in the case of countermeasure plan A shown in FIG. 8;

FIG. 12 is a diagram showing an example of an extent of impact of ransomware in the case of countermeasure plan B shown in FIG. 8;

FIG. 13 is a diagram showing an example of an extent of impact of ransomware in the case of countermeasure plan C shown in FIG. 8; and

FIG. 14 is a block diagram showing a hardware configuration example of the operation support apparatus shown in FIG. 1.

### DETAILED DESCRIPTION OF THE EMBODIMENT

An embodiment will be described with reference to the drawings. It should be noted that the embodiment described below is not intended to limit the invention as set forth in the accompanying claims and that all of the elements described in the embodiment and combinations thereof are not necessarily essential to solutions proposed by the invention.

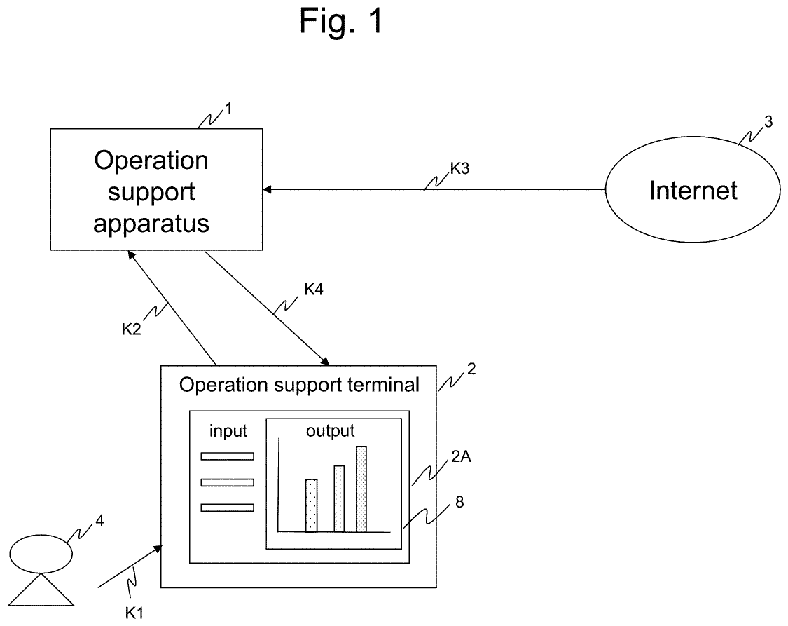

FIG. 1 is a block diagram showing a configuration of an operation support system according to a first embodiment.

In FIG. 1, the operation support system includes an operation support apparatus 1 and an operation support terminal 2. The operation support apparatus 1 predicts an impact of an incident on operations based on log information upon occurrence of the incident. As the operation support apparatus 1, for example, an AI such as a neural network can be used. In this case, the impact of the incident on operations can be learned by the AI.

The operation support terminal 2 includes a display screen 2A. The operation support terminal 2 displays a report 8 on the impact of the incident on operations as predicted by the operation support apparatus 1 on the display screen 2A.

A manager 4 causes the operation support terminal 2 to display the display screen 2A by manipulating the operation support terminal 2 (K1). The display screen 2A is, for example, a Web console screen. In addition, when an incident occurs in a business system installed inside a company, the manager 4 refers to the display screen and inputs log information upon occurrence of the incident to the operation support apparatus 1 (K2). The business system can be constituted by, for example, servers, terminals, and the like coupled via an intra-company network.

Based on the log information upon the occurrence of the incident, the operation support apparatus 1 acquires, via the Internet 3, corporate information of the corporation in which the incident had occurred and ransomware information (K3). In addition, based on the log information, the corporate information, and the ransomware information, the operation support apparatus 1 predicts an impact of the incident on operations and outputs the prediction result to the operation support terminal 2 (K4).

When the operation support terminal 2 receives the prediction result of the impact of the incident on operations, the operation support terminal 2 causes the report 8 on the impact of the incident on operations to be displayed on the display screen 2A. Accordingly, by referring to the report 8, the manager 4 can comprehend the impact of an incident having occurred inside the company on operations. Therefore, the manager 4 can acquire information for decision making upon the occurrence of an incident and reduce difficulty of making a managerial judgment with respect to what kind of countermeasure should be implemented upon the occurrence of the incident.

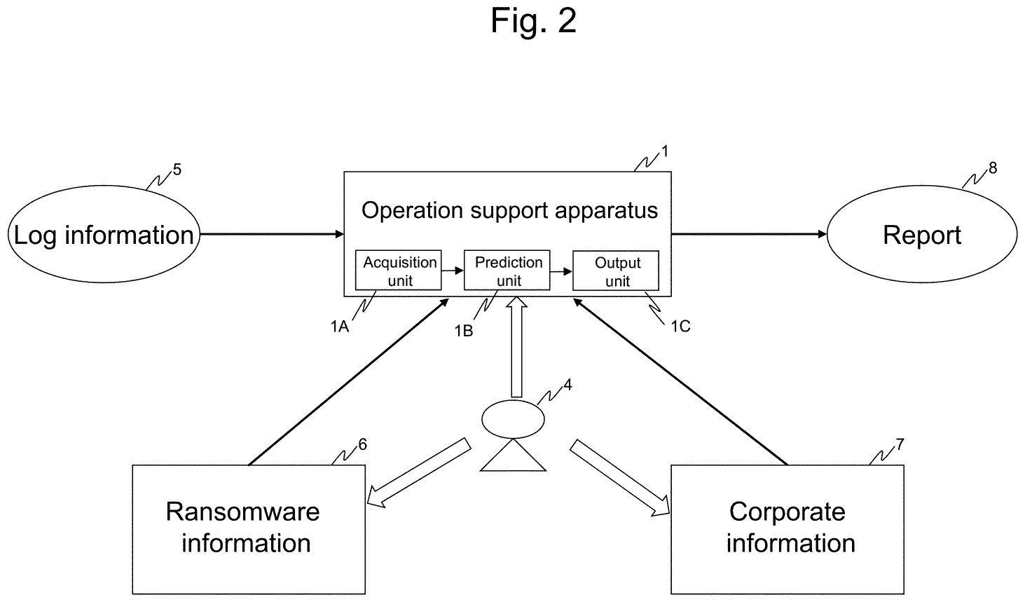

FIG. 2 is a block diagram showing a configuration of the operation support apparatus shown in FIG. 1.

In FIG. 2, the operation support apparatus 1 includes an acquisition unit 1A, a prediction unit 1B, and an output unit 1C. The acquisition unit 1A acquires log information 5 upon occurrence of an incident, corporate information 7, and ransomware information 6. The corporate information 7 includes information related to a corporation size such as the number of employees and the number of PCs (Personal Computers) owned. The ransomware information 6 includes information such as a type and an extent of impact of ransomware.

The acquisition unit 1A can acquire the log information 5 from the operation support terminal 2 shown in FIG. 1. The acquisition unit 1A can acquire the corporate information 7 and the ransomware information 6 via the Internet 3 shown in FIG. 1. Alternatively, the operation support apparatus 1 may be configured to hold the corporate information 7 and the ransomware information 6. In this case, the manager 4 can input and register the corporate information 7 and the ransomware information 6 to the operation support apparatus 1.

The prediction unit 1B predicts an impact of an incident on operations on the basis of the log information 5 upon occurrence of the incident, the corporate information 7, and the ransomware information 6. For example, on the basis of the log information 5 upon the occurrence of the incident, the corporate information 7, and the ransomware information 6, the prediction unit 1B can estimate a type of ransomware and calculate an impact on businesses in accordance with a countermeasure to the incident. As the impact on businesses in accordance with a countermeasure to the incident, the prediction unit 1B can calculate an extent of impact for each countermeasure to the ransomware and calculate an amount of financial damage and a countermeasure cost for each countermeasure to the ransomware.

The prediction unit 1B may be an AI having learned the impact of an incident on operations or a computer which executes an algorithm for calculating the impact of an incident on operations. When using an AI as the prediction unit 1B, the manager 4 can cause the AI to learn the impact of the incident on operations. When using an algorithm as the prediction unit 1B, a program describing an algorithm for calculating the impact of an incident on operations can be installed to a computer.

The output unit 1C outputs the report 8 on the impact of the incident on operations as predicted by the prediction unit 1B to the operation support terminal 2 shown in FIG. 1. For example, the output unit 1C is capable of outputting man-hours required for each countermeasure to the incident, a countermeasure cost incurred by each countermeasure to the incident, an amount of financial damage for each countermeasure to the incident, an extent of impact for each countermeasure to the incident, and the like, and causing the operation support terminal 2 to display the information in a graph format.

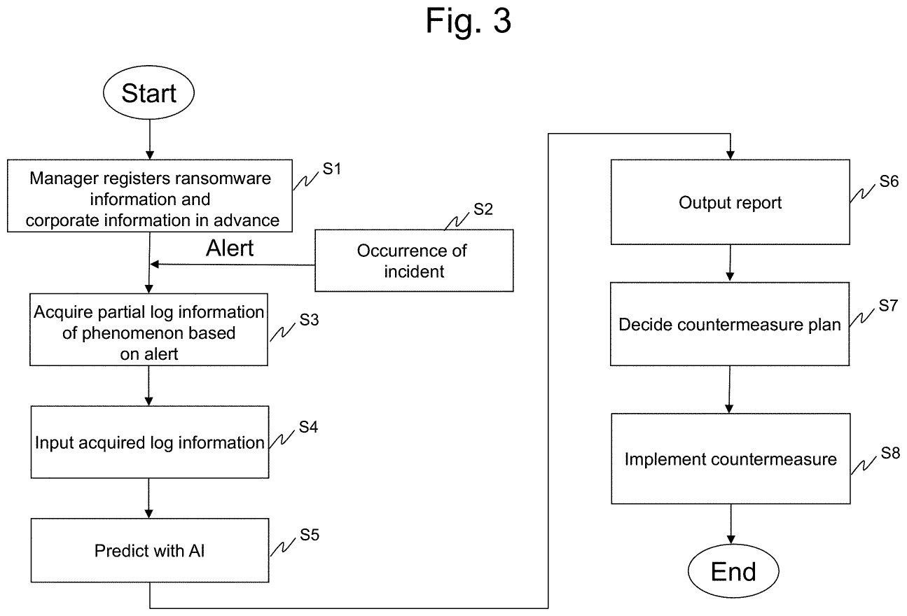

FIG. 3 is a flow chart showing an operation support method upon occurrence of an incident.

In FIG. 3, the manager 4 shown in FIG. 2 registers the corporate information 7 and the ransomware information 6 to the operation support apparatus 1 in advance (S1).

Next, when an incident occurs in the business system installed in a company (S2), the operation support terminal 2 detects an alert with respect to the incident. It should be noted that a source of occurrence of an incident is not necessarily limited to ransomware and may be a Dos (Denial of service) attack or a human cyber attack. In addition, based on the alert, the operation support terminal 2 acquires partial log information 5 of a phenomenon upon the occurrence of the incident (S3) and inputs the log information 5 to the operation support apparatus 1 (S4).

Next, the prediction unit 1B predicts an impact of the incident on operations by, for example, inputting the log information 5, the corporate information 7, and the ransomware information 6 to an AI (S5).

Next, the output unit 1C outputs, for example, the report 8 on the impact of the incident on operations as predicted by the AI to the operation support terminal 2 shown in FIG. 1 (S6).

Next, the manager 4 checks the report 8 output from the output unit 1C on the operation support terminal 2 and decides a countermeasure plan upon the occurrence of the incident (S7), and executes the decided countermeasure (S8).

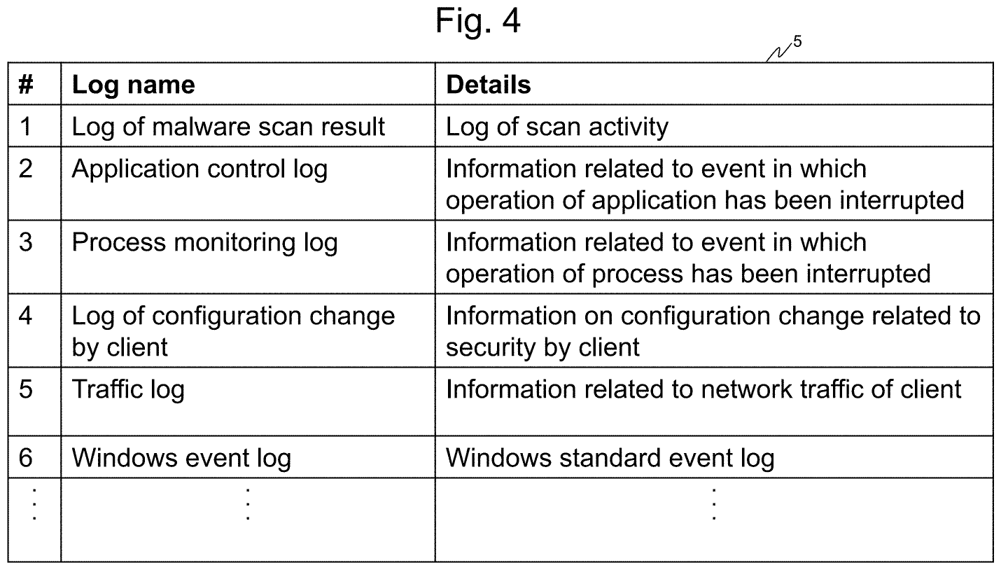

FIG. 4 is a diagram showing an example of the log information shown in FIG. 2.

In FIG. 4, the log information 5 is, for example, a log representing a malware scan result, an application control log, a process monitoring log, a log of a configuration change by a client, a traffic log, or a Windows event log.

A log of a malware scan result is a log of scan activity. An application control log is information related to an event in which an operation of an application has been interrupted. A process monitoring log is information related to an event in which an operation of a process has been interrupted. A log of a configuration change by a client is information on a configuration change related to security by the client. A traffic log is information related to network traffic of a client. A Windows event log is a Windows standard event log.

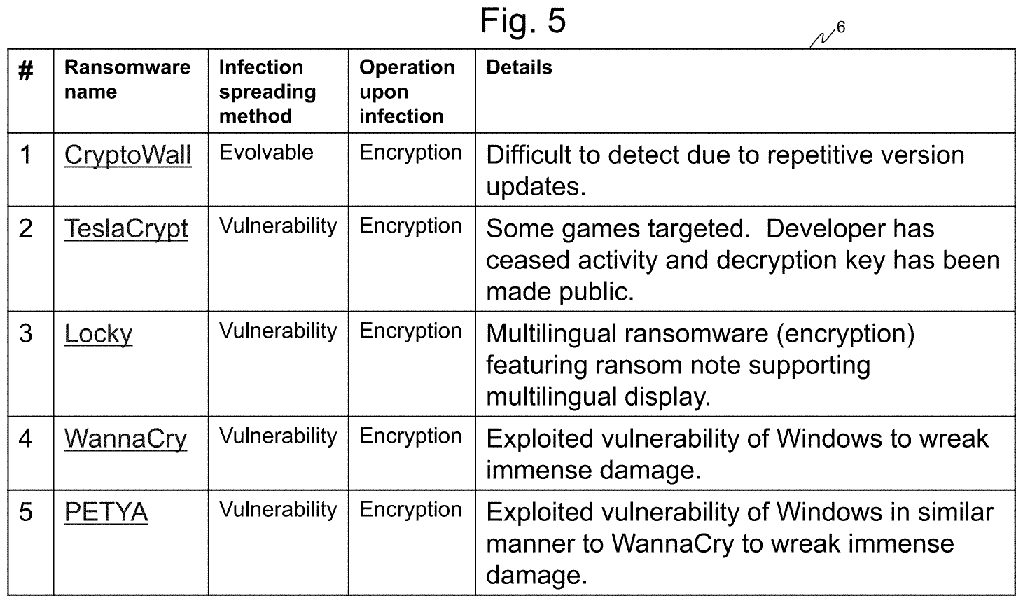

FIG. 5 is a diagram showing an example of ransomware information shown in FIG. 2.

In FIG. 5, the ransomware information 6 includes a ransomware name, an infection spreading method, an operation upon infection, and details of the ransomware. Examples of ransomware names include CryptoWall, TeslaCrypt, Locky, WannaCry, and PETYA.

In terms of an infection spreading method, evolvable ransomware spreads infection by repetitive updating. Since evolvable ransomware performs network communication to update, evolvable ransomware may possibly have a characteristic network traffic log. Vulnerability-type ransomware spreads infection by exploiting vulnerability of an OS (Operating System) such as Windows.

In terms of an operation upon infection, encryption-type ransomware (a crypter) encrypts all files on a PC or the like to make the files inaccessible. Screen locking-type ransomware (a blocker) locks a screen of a PC or the like to make the PC nonmanipulatable.

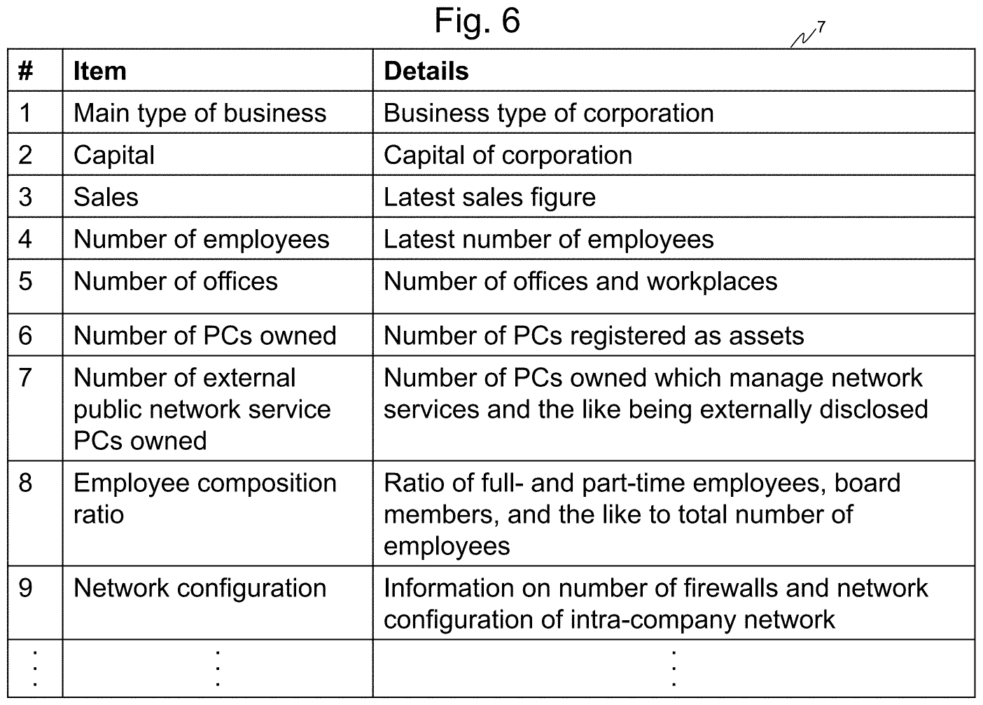

FIG. 6 is a diagram showing an example of corporate information shown in FIG. 2.

In FIG. 6, as items, the corporate information 7 includes, for example, main type of business, capital, sales, number of employees, number of offices, number of PCs owned, number of external public network service PCs owned, employee composition ratio, and network configuration. In addition, the corporate information 7 includes details of each item.

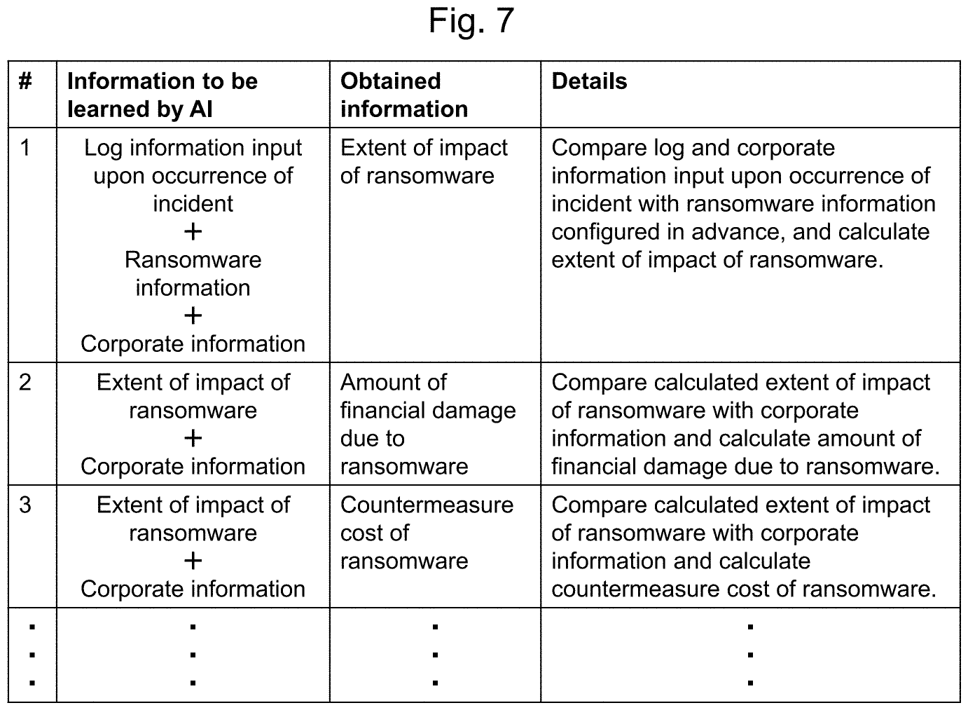

FIG. 7 is a diagram showing a learning method of an AI used as the prediction unit shown in FIG. 2.

In FIG. 7, when obtaining an extent of impact of ransomware from the AI, the log information 5 upon occurrence of an incident, the corporate information 7, and the ransomware information 6 are used as learning data. In this case, the AI calculates the extent of impact of ransomware by comparing the log information 5 and the corporate information 7 input upon occurrence of an incident with the ransomware information 6 configured in advance.

When obtaining an amount of financial damage due to ransomware from the AI, the extent of impact of the ransomware and the corporate information 7 are used as learning data. In this case, the AI calculates the amount of financial damage due to the ransomware by comparing the calculated extent of impact of the ransomware with the corporate information 7.

When obtaining a countermeasure cost from the AI, the extent of impact of the ransomware and the corporate information 7 are used as learning data. In this case, the AI calculates the countermeasure cost by comparing the calculated extent of impact of the ransomware with the corporate information 7.

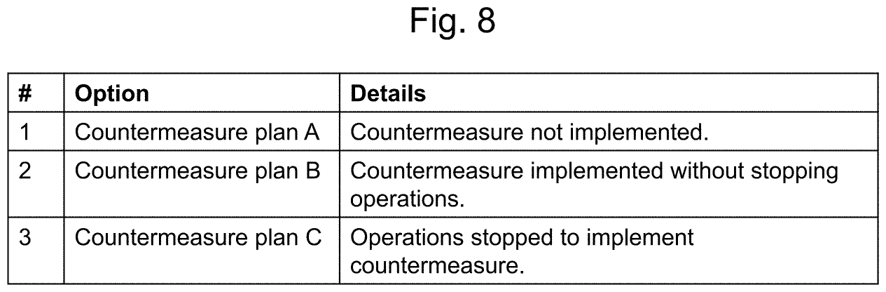

FIG. 8 is a diagram showing examples of countermeasure plans upon occurrence of an incident.

In FIG. 8, for example, countermeasure plans A to C are configured as options of a countermeasure upon occurrence of an incident. With countermeasure plan A, no countermeasure is implemented upon occurrence of an incident. With countermeasure plan B, a countermeasure is implemented without stopping operations. With countermeasure plan C, operations are stopped to implement a countermeasure.

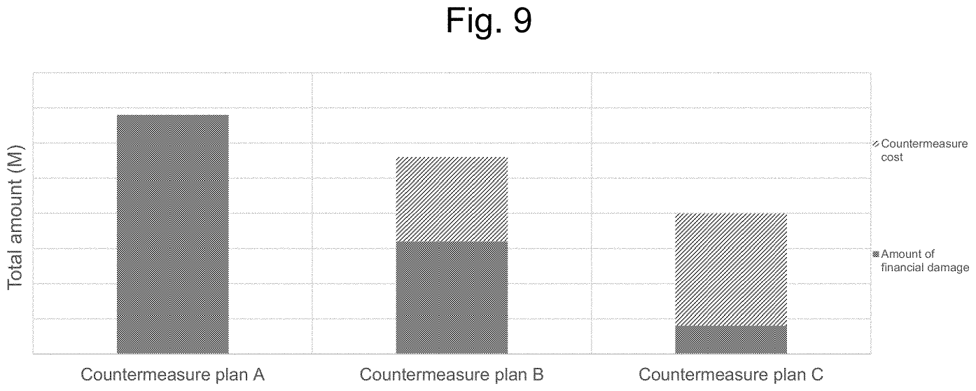

FIG. 9 is a diagram showing an example of a report for each countermeasure plan shown in FIG. 8.

In FIG. 9, with countermeasure plan A, since no countermeasure is implemented upon the occurrence of an incident, there is no countermeasure cost and only an amount of financial damage is incurred. With countermeasure plans B and C, since a countermeasure is implemented upon the occurrence of an incident, both a countermeasure cost and an amount of financial damage are incurred.

A comparison of a total amount of the countermeasure cost and the amount of financial damage among the countermeasure plans show that, with countermeasure plan A, the amount of financial damage increases since no countermeasure is implemented and the total amount in the case of countermeasure plan A is larger than the total amount in the cases of countermeasure plans B and C. Therefore, by having the operation support apparatus 1 display the total amount in the case of each of countermeasure plans A to C shown in FIG. 9 in a graph format as the report 8 on the operation support terminal 2, the manager 4 can obtain information for decision making indicating that it is better to implement some kind of countermeasure upon occurrence of an incident as compared to not implementing any countermeasures upon occurrence of the incident.

When some kind of countermeasure is implemented, although the countermeasure cost in the case of countermeasure plan C is larger than that of countermeasure plan B because a countermeasure is implemented by stopping operations, the amount of financial damage is smaller.

With countermeasure plan C, since a countermeasure is implemented by stopping operations, a best possible countermeasure can be implemented with respect to the occurrence of an incident and the amount of financial damage can be minimized. By comparison, with countermeasure plan B, since a countermeasure is implemented without stopping operations, only an insufficient countermeasure can be implemented with respect to the occurrence of an incident and the amount of financial damage increases accordingly.

Therefore, a comparison of the total amount of the countermeasure cost and the amount of financial damage between countermeasure plans B and C reveal that the total amount in the case of countermeasure plan B is larger than the total amount in the case of countermeasure plan C.

When making a decision as to what kind of countermeasure should be implemented without referring to the report 8 on the total amount for each of countermeasure plans A to C shown in FIG. 9, normally, there is a tendency to lean toward a managerial judgment that a smaller loss is incurred when implementing a countermeasure without stopping operations as compared to implementing a countermeasure by stopping operations and, consequently, countermeasure plan B may be selected.

On the other hand, by having the operation support apparatus 1 display a total amount in the case of each of countermeasure plans A to C shown in FIG. 9 in a graph format as the report 8 on the operation support terminal 2, the manager 4 can obtain information for decision making indicating that a smaller loss is incurred when implementing a countermeasure by stopping operations as compared to implementing a countermeasure without stopping operations.

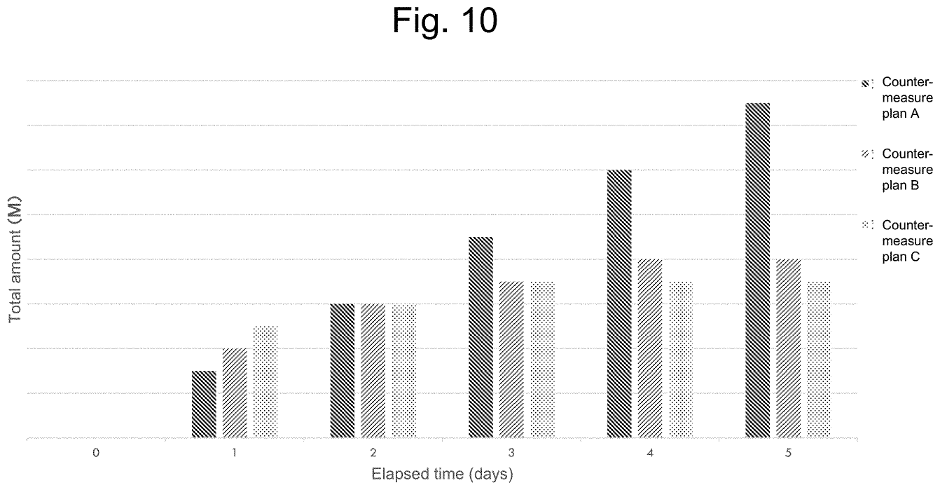

FIG. 10 is a diagram showing another example of a report for each countermeasure plan shown in FIG. 8.

In FIG. 10, although the total amount of the countermeasure cost and the amount of financial damage for countermeasure plan A is smaller than those of countermeasure plans B and C on the first day after the occurrence of an incident because no countermeasure is implemented upon occurrence of the incident, the total amount increases as more time elapses from the occurrence of the incident.

Therefore, by having the operation support apparatus 1 display a trend of the total amount in the case of each of countermeasure plans A to C shown in FIG. 10 in a graph format as the report 8 on the operation support terminal 2, the manager 4 can obtain information for decision making indicating that it is better to implement some kind of countermeasure upon occurrence of an incident as compared to not implementing any countermeasures upon the occurrence of the incident.

When some kind of countermeasure is implemented, on the first day after the occurrence of an incident, since countermeasure plan C involves implementing a countermeasure by stopping operations, the countermeasure cost thereof is larger than that of countermeasure plan B and, consequently, the total amount in the case of countermeasure plan C is larger than that in the case of countermeasure plan B. On the other hand, with countermeasure plan B, since a countermeasure is implemented without stopping operations, implementing the countermeasure requires more time than countermeasure plan C. Assuming that it takes four days to complete the countermeasure with countermeasure plan B and three days to complete the countermeasure with countermeasure plan C, in the case of countermeasure plan B, an increase in the total amount stops after four days from the occurrence of the incident but, in the case of countermeasure plan C, an increase in the total amount stops after three days from the occurrence of the incident. Therefore, after four days from the occurrence of the incident, the total amount in the case of countermeasure plan B exceeds the total amount in the case of countermeasure plan C.

Therefore, by having the operation support apparatus 1 display a trend of the total amount in the case of each of countermeasure plans A to C shown in FIG. 10 in a graph format as the report 8 on the operation support terminal 2, the manager 4 can obtain information for decision making indicating that ultimate loss is smaller when implementing a countermeasure by stopping operations as compared to implementing a countermeasure without stopping operations.

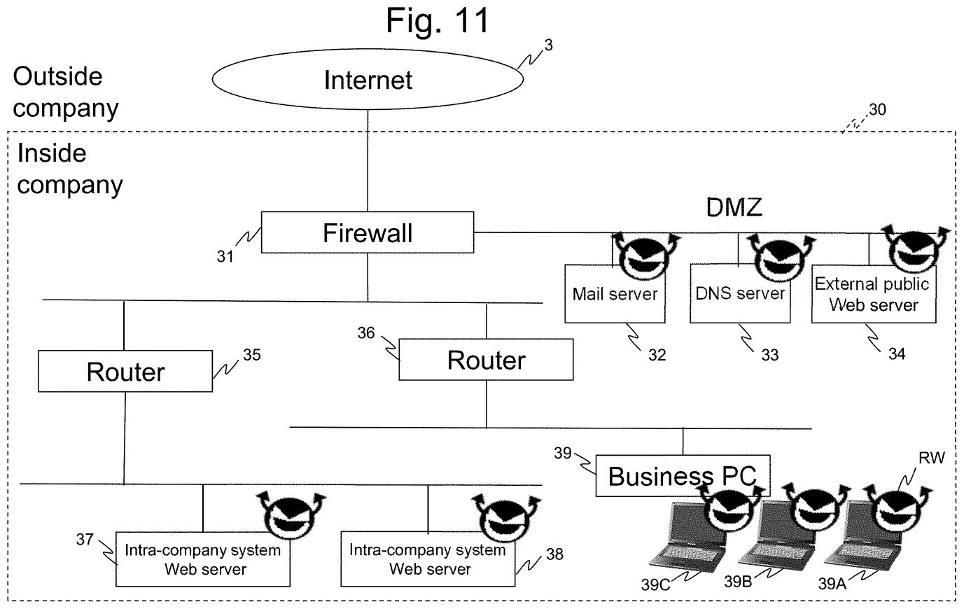

FIG. 11 is a diagram showing an example of an extent of impact of ransomware in the case of countermeasure plan A shown in FIG. 8.

In FIG. 11, as a business system, a firewall 31, a mail server 32, a DNS (Domain Name System) server 33, an external public Web server 34, routers 35 and 36, intra-company system Web servers 37 and 38, and a business PC 39 are provided inside a company 30. As the business PC 39, a plurality of PCs 39A to 39C are provided. The mail server 32, the DNS server 33, and the external public Web server 34 are provided in a DMZ (DeMilitarized Zone).

The firewall 31 is coupled to the Internet 3, the mail server 32, the DNS server 33, the external public Web server 34, and the routers 35 and 36. The intra-company system Web servers 37 and 38 are coupled to the router 35, and the business PC 39 is coupled to the router 36.

Now, let us assume that the PC 39A is the first to be infected by ransomware RW. In this case, since no countermeasure is implemented in countermeasure plan A, even when the firewall 31 or the routers 35 and 36 are in place, depending on how much time elapses, the mail server 32, the DNS server 33, the external public Web server 34, and the intra-company system Web servers 37 and 38 are also at a risk of infection by the ransomware RW as long as the servers are on a same network inside the company 30.

Therefore, by having the operation support apparatus 1 shown in FIG. 2 output an extent of impact of an infection to the ransomware RW when no countermeasure is implemented as the report 8, the manager 4 is able to access the extent of impact to the business system inside the company 30 and use the report 8 as information for decision making in regards to whether or not a countermeasure is to be implemented upon occurrence of an incident.

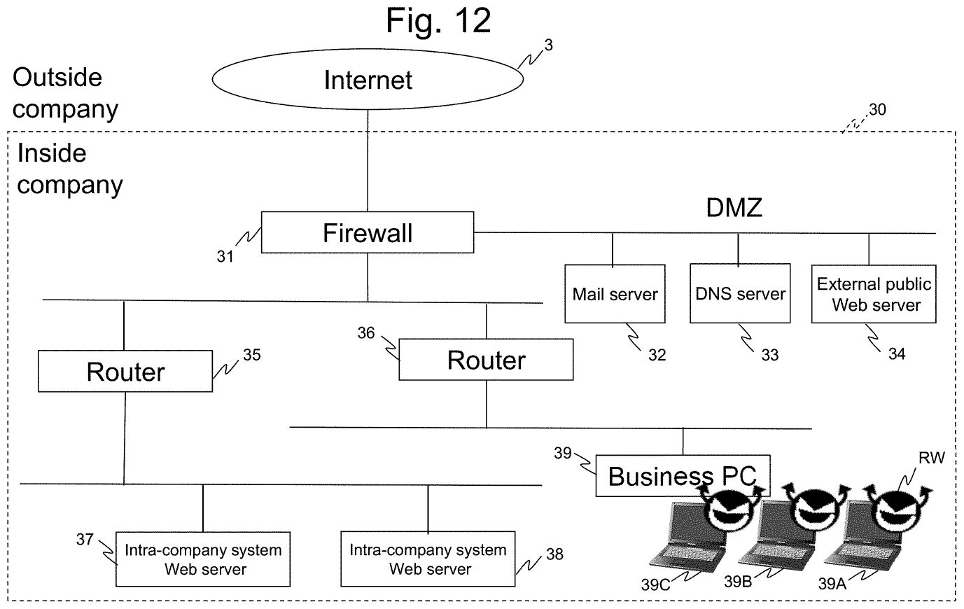

FIG. 12 is a diagram showing an example of an extent of impact of ransomware in the case of countermeasure plan B shown in FIG. 8.

In FIG. 12, since a countermeasure is implemented without stopping operations in countermeasure plan B, implementing the countermeasure may take time. Therefore, when the PC 39A is first inspected by the ransomware RW, there is a risk that the infection may immediately spread to the PCs 39B and 39C on a same segment.

Therefore, by having the operation support apparatus 1 shown in FIG. 2 output an extent of impact of an infection to the ransomware RW when a countermeasure is implemented without stopping operations as the report 8, the manager 4 is able to access the extent of impact to the business system inside the company 30 and use the report 8 as information for decision making in regards to whether or not a countermeasure is to be implemented without stopping operations upon occurrence of an incident.

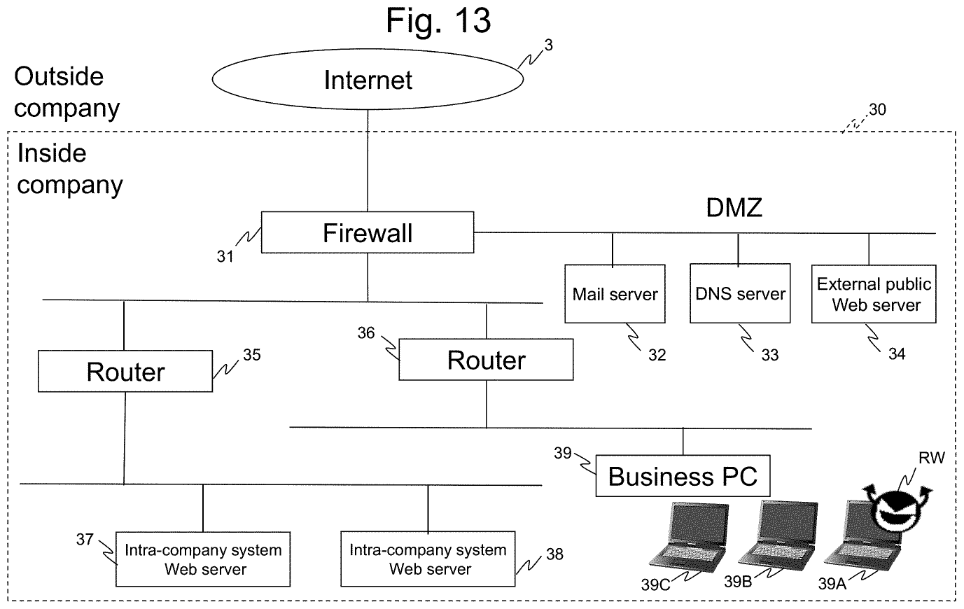

FIG. 13 is a diagram showing an example of an extent of impact of ransomware in the case of countermeasure plan C shown in FIG. 8.

In FIG. 13, since a countermeasure is implemented by stopping operations in countermeasure plan C, the countermeasure can be swiftly implemented. Therefore, even when the PC 39A is first inspected by the ransomware RW, there is a possibility that the infection can be prevented from spreading further.

Therefore, by having the operation support apparatus 1 shown in FIG. 2 output an extent of impact of an infection to the ransomware RW when a countermeasure is implemented by stopping operations as the report 8, the manager 4 is able to access the extent of impact to the business system inside the company 30 and use the report 8 as information for decision making in regards to whether or not a countermeasure is to be implemented by stopping operations.

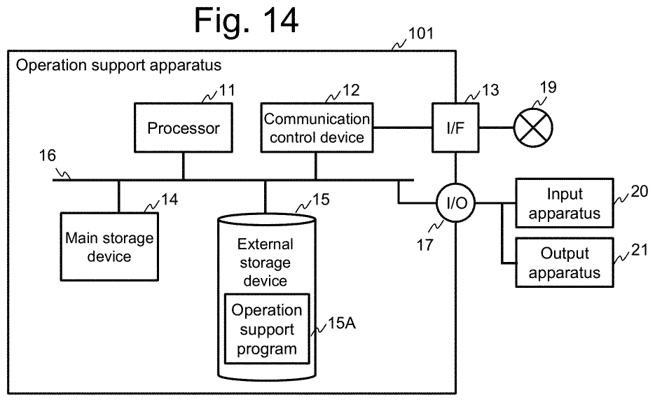

FIG. 14 is a block diagram showing a hardware configuration example of the operation support apparatus shown in FIG. 1.

In FIG. 14, an operation support apparatus 101 includes a processor 11, a communication control device 12, a communication interface 13, a main storage device 14, and an external storage device 15. The processor 11, the communication control device 12, the communication interface 13, the main storage device 14, and the external storage device 15 are coupled to each other via an internal bus 16. The main storage device 14 and the external storage device 15 can be accessed from the processor 11.

In addition, an input apparatus 20 and an output apparatus 21 are provided outside of the operation support apparatus 101. The input apparatus 20 and the output apparatus 21 are coupled to the internal bus 16 via an input/output interface 17. Examples of the input apparatus 20 include a keyboard, a mouse, a touch panel, a card reader, and an audio input apparatus. Examples of the output apparatus 21 include a screen display apparatus (such as a liquid crystal monitor, an organic EL (Electro Luminescence) display, or a graphic card), an audio output apparatus (such as a speaker), and a printing apparatus.

The processor 11 is hardware responsible for operation control of the entire operation support apparatus 101. The processor 11 may be a CPU (Central Processing Unit) or a GPU (Graphics Processing Unit). The processor 11 may be a single-core processor or a multi-core processor. The processor 11 may include a hardware circuit (for example, an FPGA (Field-Programmable Gate Array) or an ASIC (Application Specific Integrated Circuit)) which performs a part of or all of the processing. The processor 11 may include a neural network.

The main storage device 14 can be constituted by, for example, a semiconductor memory such as an SRAM or a DRAM. A program currently being executed by the processor 11 can be stored in the main storage device 14 or a work area used by the processor 11 to execute the program can be provided in the main storage device 14.

The external storage device 15 is a storage device having a large storage capacity and examples thereof include a hard disk apparatus and an SSD (Solid State Drive). The external storage device 15 is capable of holding executable files of various programs and data to be used when executing the programs. An operation support program 15A can be stored in the external storage device 15. The operation support program 15A may be software that can be installed in the operation support apparatus 101 or may be built into the operation support apparatus 101 as firmware.

The communication control device 12 is hardware equipped with a function for controlling communication with the outside. The communication control device 12 is coupled to a network 19 via the communication interface 13. The network 19 may be a WAN (Wide Area Network) such as the Internet, a LAN (Local Area Network) such as WiFi or the Ethernet (registered trademark), or a combination of a WAN and a LAN.

The input/output interface 17 converts data input from the input apparatus 20 into a data format that can be processed by the processor 11 and converts data output from the processor 11 into a data format that can be processed by the output apparatus 21.

By loading the operation support program 15A to the main storage device 14 and executing the operation support program 15A, the processor 11 can predict an impact of an incident on operations on the basis of log information upon occurrence of an incident, corporate information, and ransomware information. At this point, the processor 11 is capable of realizing the functions of the prediction unit 1B shown in FIG. 2.

It should be noted that the execution of the operation support program 15A may be shared among a plurality of processors or computers. Alternatively, the processor 11 may be configured to instruct a cloud computer or the like to execute all of or a part of the operation support program 15A via the network 19 and to receive an execution result thereof.

Moreover, it is to be understood that the present invention is not limited to the embodiment described above and is intended to cover various modifications. For example, the embodiment presented above has been described in detail to provide a clear understanding of the present invention, and the present invention is not necessarily limited to embodiments including all of the components described above. In addition, a part of components of a certain embodiment can be replaced with components of another embodiment, and components of another embodiment can be added to components of a certain embodiment. Furthermore, a part of the components of each embodiment can be added to, deleted from, or replaced with other components. Moreover, the respective components, functions, processing units, processing means, and the like described above may be partially or entirely realized by hardware by, for example, designing with integrated circuits or the like.

What is claimed is:

1. An operation support apparatus, comprising:
an acquisition unit configured to acquire log information upon occurrence of an incident;
a prediction unit configured to predict an impact of the incident on operations on the basis of the log information; and
an output unit configured to output a prediction result predicted by the prediction unit.

2. The operation support apparatus according to claim 1, wherein
the acquisition unit is configured to acquire corporate information and ransomware information, and
the prediction unit is configured to predict an impact of the incident on operations on the basis of the log information, the corporate information, and the ransomware information.

3. The operation support apparatus according to claim 2, wherein
the prediction unit is configured to predict an impact on businesses in accordance with a countermeasure to the incident, and
the output unit is configured to output at least one of man-hours required for each countermeasure to the incident, a countermeasure cost incurred by each countermeasure to the incident, an amount of financial damage for each countermeasure to the incident, and an extent of impact for each countermeasure to the incident.

4. The operation support apparatus according to claim 2, wherein
the prediction unit is configured to
calculate an extent of impact of ransomware for each countermeasure on the basis of the log information, the corporate information, and the ransomware information, and
calculate an amount of financial damage and a countermeasure cost of the ransomware for each countermeasure on the basis of the extent of impact of the ransomware and the corporate information.

5. The operation support apparatus according to claim 2, wherein
the prediction unit is configured to predict, using an elapsed time of the occurrence of the incident as a time axis, a trend of an impact of the incident on operations for each countermeasure.

6. An operation support terminal, comprising:
an input unit configured to receive input log information upon occurrence of an incident; and
a display unit configured to display an impact of the incident on operations.

7. An operation support method to be executed by a processor, wherein
the processor
acquires log information upon occurrence of an incident;
predicts an impact of the incident on operations on the basis of the log information; and
outputs a prediction result of the impact of the incident on operations.
